(19) United States
(12) Patent Application Publication
(10) Pub. No.: US 2016/0008797 A1
(43) Pub. Date: Jan. 14, 2016

(54) METHOD FOR THE SYNTHESIS OF POROUS INORGANIC MATERIAL, CATALYTIC CRACKING OF PETROLEUM HYDROCARBONS AND PREPARATION OF CATALYST THEREOF

(71) Applicant: ZHANJIANG GIANT SUCCESS INVESTMENT CO.,LTD., Guangdong Province (CN)

(72) Inventors: Letian Chen, Guangdong Province (CN); Jianzhong Chen, Guangdong Province (CN)

(21) Appl. No.: 14/685,819

(22) Filed: Apr. 14, 2015

(30) Foreign Application Priority Data
Jun. 4, 2014 (CN) 201410245099.1
Jun. 4, 2014 (CN) 201410245587.2
Jun. 4, 2014 (CN) 201410245588.7

(51) Int. Cl. B01J 29/46; B01J 29/14; B01J 29/40; B01J 21/16; B01J 21/08; C01B 39/38; B01J 35/00; B01J 37/02; B01J 37/06; B01J 37/08; C10G 11/05; C01B 39/24; B01J 29/08; B01J 21/04

(52) U.S. Cl. CPC B01J 29/46; B01J 29/084; B01J 29/146; B01J 29/40; B01J 21/16; B01J 21/08; B01J 21/04; B01J 35/0006; B01J 37/0236; B01J 37/06; B01J 37/08; C10G 11/05; C01B 39/24; C01B 39/38

(57) ABSTRACT

A method for synthesis of porous inorganic materials, preparation of a catalyst and catalytic cracking of petroleum hydrocarbons thereof includes processes for synthesis of porous inorganic materials and preparation of the catalytic cracking catalyst and catalytic cracking of petroleum hydrocarbons. The synthesis process is advantaged in low cost in raw materials; the porous inorganic material has various pore structures; and transitional metal used overcomes the defects of the catalytic properties. The porous inorganic material serving as the main active ingredient and containing crystalline aluminum silicate zeolite structures provides surface acidity required by the catalytic reaction. The surface acidity is flexibly adjusted. The hierarchical pore profile improves the accessibility of the active center of the zeolite structure and favors the reaction efficiency and benefits of the petroleum hydrocarbon cracking, and reduces the negative effects caused by diffusion limit. The catalyst containing the porous inorganic material has low manufacturing cost and better properties.

### TECHNICAL FIELD

The present invention relates to the technical field of inorganic material preparation, petroleum hydrocarbon conversion and catalysts, in particular to a method for synthesis of a porous inorganic material, catalytic cracking of petroleum hydrocarbons and preparation of a catalyst thereof.

### DESCRIPTION OF RELATED ART

Due to large specific surfaces, porous inorganic materials are widely used as catalytic materials during preparation of catalysts, so various porous inorganic materials have been developed, for example, the zeolite type inorganic materials, including A zeolite type, X zeolite type, Y zeolite type, ZSM series zeolite type, mordenite type and β zeolite type. Besides, amorphous porous inorganic materials include various silica oxides, aluminum oxides and silicon-aluminum oxides.

However, the many porous inorganic materials available now still fail to satisfy the increasing needs of developing catalysts with higher performance as society develops.

The technical cracking the petroleum hydrocarbon raw material into the fuel oil and light olefins is a key process for meeting the traffic transport demands and the petroleum industrial production demands. A catalyst meeting the needs of cracking the petroleum hydrocarbons can be classified into three types: the first type are the catalysts using Y zeolites as the active ingredients, wherein the Y zeolites can be prepared by crystallization, the prepared Y zeolites undergo the rare earth ion exchange and hydro-thermal ultrastability processing, and finally the cracking catalysts are obtained; the second type are catalysts using ZSM-5 zeolites as the active ingredients, wherein the ZSM-5 zeolites are prepared by crystallization, the prepared ZSM-5 zeolites undergo the rare earth ion exchange and calcinating processing, and finally the cracking catalysts are obtained; and the third type are compounds of the former two types of catalysts.

However, the above-mentioned cracking catalysts fail to satisfy the increasing needs of developing advanced petroleum hydrocarbon cracking technologies as society develops.

The petroleum hydrocarbon cracking catalyst is a silicate porous inorganic material. To efficiently crack the petroleum hydrocarbons, various inorganic materials have been developed, for example: zeolite type inorganic materials, including A zeolite, X zeolite, ZSM-5 series zeolites, mordenite and β zeolites, and amorphous porous material, including various silica oxides, aluminum oxides and silicon-aluminum oxides. The catalysts prepared by those materials are widely applied in the actual industrial production.

However, the many cracking catalysts available now still fail to satisfy the increasing industrial needs as society develops, and development of the petroleum hydrocarbon cracking catalysts with better performance is an urgent need.

### BRIEF SUMMARY OF THE INVENTION

The objective of the embodiments of the present invention is to provide a method for synthesis of the porous inorganic material, catalytic cracking of petroleum hydrocarbons and preparation of the catalyst thereof, aiming at solving the problem that the current porous inorganic materials fail to meet the needs of developing catalysts with better properties and the problem that the cracking catalysts still fail to meet the needs of developing advanced petroleum hydrocarbon cracking technology as society develops.

The embodiments of the present invention are implemented in this way. A method for synthesis of the porous inorganic material, catalytic cracking of petroleum hydrocarbons and preparation of the catalyst thereof includes: synthesis process of the porous inorganic material, catalytic cracking process of petroleum hydrocarbons and preparation of the catalytic cracking catalyst of petroleum hydrocarbons.

The process for synthesizing a porous inorganic material comprises:

Step 1) calcinating natural clay for 0.5-5 h at a temperature of 500˜1,000° C.;

Step 2) adding the calcined clay into the silicon-containing solution, and mixing well;

Step 3) keeping the obtained slurry standing at room temperature for 12-48 h, then adding metal ions and mixing well;

Step 4) crystallizing the obtained slurry for 10-48 h at a temperature of 90˜250° C. in a sealed conditioning, and filtering the slurry to obtain filer cakes; and,

Step 5) oven drying the obtained filer cakes to obtain the porous inorganic material.

According to the process for catalytic cracking of the petroleum hydrocarbons using the porous inorganic material and catalyst, the petroleum hydrocarbons and the catalyst contact each other at a temperature of 460˜680° C. with the existence of vapor; the catalyst-oil ratio is 4˜40; the vapor is 1%˜80% of the petroleum hydrocarbon weight; by weight percentage, the catalyst includes 10%˜70% of porous inorganic material, 0%˜50% of kaolin, 0%˜30% of pseudo-boehmite, 0%˜15% of silicon-contained sol and 0%˜30% of aluminum sol;

According to the preparation process of the cracking catalyst of petroleum hydrocarbons, the catalyst includes the following ingredients by weight percentage: 10%˜70% of porous inorganic material, 0%˜60% of kaolin, 0%˜30% of pseudo-boehmite, 0%˜15% of silicon-contained sol and 0%˜30% of aluminum sol. The preparation process comprises the following steps:

Step 1) dispersing the pseudo-boehmite using water, controlling the solid content of the slurry to be 10%˜25%, adding the hydrochloric acid solution according to the 0.10-0.35 acid-to-alumina ratio weight/weight, wherein the acid weight is the weight of hydrochloric acid solution containing 36% weight hydrochloric acid, and mixing well;

Step 2) slowly adding the water glass solution into the slurry obtained in Step 1 while stirring quickly, keeping stirring for 10-120 min, then adding aluminum sol solution, and mixing well;

Step 3) adding the pre-dispersed porous inorganic material slurry and kaolin slurry into the slurry obtained in step 2, stirring the mixture for over 10 min, and then forming catalyst slurry; and,

Step 4) spray forming the catalyst slurry, drying, washing, and calcinating in a vapor atmosphere.

Furthermore, in the Step 1 of the method for synthesizing the porous inorganic material, the natural clay is kaolinite, montmorillonite or illite; the content of the aluminium oxide in the kaolinite, montmorillonite and illite is 20%˜50%; the calcinating temperature of the natural clay is preferably 700˜850° C., and the calcinating time is preferably 1-4 h;

in Step 2 of the process for synthesizing the porous inorganic material, the silicon-contained solution is water glass; the modulus of the water glass is 1.0˜4.0;

in Step 3 of the process for synthesizing the porous inorganic material, the metal ions include iron, cobalt and nickel ions; the pH value of the slurry is greater than 7;

the porous inorganic material contains the crystalline aluminum silicate zeolite structure; the Crystalline aluminum silicate zeolite is of Y zeolite, ZSM-5 zeolite or mixture of the Y zeolite and ZSM-5 zeolite; the specific surface of the porous inorganic material is 70˜700 m2/g, with different framework structures.

Furthermore, the process for synthesizing a porous inorganic material comprises: weighing 50 g kaolinite, calcinating for 4.5 h at a temperature of 550° C., preparing 400 ml water glass solution with a modulus of 1.5, adding the calcined kaolinite, mixing well, keeping standing for 24 h at room temperature, placing the slurry in a sealed container; crystallizing the slurry for 32 h at a temperature of 75° C., then adding 8.2 g prepared ferric oxide hydrate, based on ferric oxide, into the slurry, stirring the mixed solution to mix the cobalt and other ingredients well, crystallizing the mixture for 28 h at a temperature of 95° C. in a sealed condition, naturally cooling to room temperature, opening the container, filtering the slurry, and flushing for 5 times with the washing water to obtain the porous inorganic material;

the process for synthesizing a porous inorganic material comprises: weighing 50 g montmorillonite, calcinating for 2.5 h at a temperature of 750° C., preparing 500 ml water glass solution with a modulus of 2.0, adding the calcined montmorillonite, mixing well, keeping standing for 42 h at room temperature, placing the slurry in a sealed container; crystallizing the slurry for 40 h at a temperature of 85° C., then adding 5.5 g prepared cobalt oxide hydrate, based on cobalt oxide, into the slurry, stirring the mixed solution to mix the cobalt and other ingredients well, crystallizing the mixture for 36 h at a temperature of 95° C. in a sealed condition, naturally cooling to room temperature, opening the container, filtering the slurry, and flushing for 5 times with the washing water to obtain the porous inorganic material.

Furthermore, the process for synthesizing a porous inorganic material comprises: weighing 50 g illite, calcinating for 3.0 h at a temperature of 600° C., preparing 900 ml water glass solution with a modulus of 2.2, adding the calcined illite, mixing well, keeping standing for 15 h at room temperature, placing the slurry in a sealed container; crystallizing the slurry for 46 h at a temperature of 140° C., then adding 3.0 g prepared nickel oxide hydrate, based on nickel oxide, into the slurry, stirring the mixed solution to mix the nickel and other ingredients well, crystallizing the mixture for 46 h at a temperature of 205° C. in a sealed condition, naturally cooling to room temperature, opening the container, filtering the slurry, and flushing for 5 times with the washing water to obtain the porous inorganic material.

The process for synthesizing a porous inorganic material comprises: weighing 50 g montmorillonite, calcinating for 2.5 h at a temperature of 750° C., preparing 1,000 ml water glass solution with a modulus of 2.8, adding the calcined montmorillonite, mixing well, keeping on standing for 38 h at room temperature, placing the slurry in a sealed container; crystallizing the slurry for 20 h at a temperature of 125° C., then adding 4.5 g prepared ferric oxide hydrate, based on ferric oxide, into the slurry, stirring the mixed solution to mix the iron and other ingredients well, crystallizing the mixture for 40 h at a temperature of 220° C. in a sealed condition, naturally cooling to room temperature, opening the container, filtering the slurry, and flushing for 5 times with the washing water to obtain the porous inorganic material.

the method for synthesizing a porous inorganic material comprises: weighing 50 g kaolinite, calcinating for 2.0 h at a temperature of 800° C., preparing 1,000 ml water glass solution with a modulus of 2.5, adding the calcined kaolinite, mixing well, keeping standing for 24 h at room temperature, placing the slurry in a sealed container; crystallizing the slurry for 32 h at a temperature of 95° C., then adding 4.8 g prepared ferric oxide hydrate, based on ferric oxide, into the slurry, stirring the mixed solution to mix the iron and other ingredients well, crystallizing the mixture for 35 h at a temperature of 150° C. in a sealed condition, naturally cooling to room temperature, opening the container, filtering the slurry, and flushing for 5 times with the washing water to obtain the porous inorganic material.

Furthermore, according to the process for catalytic cracking of the petroleum hydrocarbons, the petroleum hydrocarbons include vacuum gas oil, atmospheric residual oil, vacuum residual oil, coker gas oil, hydrogenated vacuum gas oil, hydrogenated atmospheric residual oil, hydrogenated vacuum residual oil, and hydrogenated coker gas oil;

the petroleum hydrocarbons have a carbon residue content of 0%˜9.0% and a density of 0.85%˜0.99 g/ml;

the contact temperature is preferably 470˜550° C.; the catalyst-to-oil ratio is preferably 4˜12; the dose of the vapor is preferably 10%˜70% of the petroleum hydrocarbons.

Furthermore, according to the process for catalytic cracking of the petroleum hydrocarbons, the preparation steps of the catalyst include: uniformly mixing the pseudo-boehmite slurry, silicon-contained sol, aluminum sol, porous inorganic material slurry and kaolin slurry according to the weight percentage composition of the catalyst: 10%˜70% of porous inorganic material, 0%˜50% of kaolin, 0%˜30% of pseudo-boehmite, 0%˜15% of silicon-contained sol and 0%˜30% of aluminum sol, obtaining catalyst slurry, atomizing, drying, exchanging with rare earth, washing, drying, and calcinating in a hydrothermal atmosphere;

the silicon-contained sol is water glass solution with a modulus of 2.9˜3.2 and a solid content of 5%˜15%.

The material adding sequence can be adjusted flexibly.

The content of the porous inorganic material is preferably 30%˜60%; the content of the kaolin is preferably 20%˜40%; the content of the pseudo-boehmite is preferably 10%˜20%; the content of the aluminum sol is preferably 5%˜25%;

the preparation process of the porous inorganic material comprises: calcinating and activating the kaolin, mixing the calcined kaolin with the water glass solution well, keeping on standing, crystallizing, adding ferric oxides, re-crystallizing, washing and exchanging;

the porous inorganic material features a Y-shaped zeolite structure or a ZSM-5 zeolite structure or mixture of those two structures.

Furthermore, according to the preparation process of the petroleum hydrocarbon catalyst, the silicon-contained solution is water glass with a modulus of 2.9˜3.2.

Furthermore, according to the preparation process of the petroleum hydrocarbon catalyst, the preparation steps of the porous inorganic material further include:

Step 1) calcinating the kaolin for 0.5-5 h at a temperature of 500˜1,100° C.;

Step 2) adding the clay calcined in Step 1 into the silicon-contained solution, and mixing well;

Step 3) keeping the slurry obtained in Step 2 on landing for 12-48 h at room temperature, then crystallizing the slurry for 10-48 h at a temperature of 70˜150° C. in a sealed condition, next adding the ferric oxide, and stirring the mixed solution well;

Step 4) crystallizing the obtained slurry obtained in Step 3 for 10-48 h at a temperature of 90˜250° C. in a sealed conditioning, and filtering the slurry to obtain filer cakes, and oven drying the filer cakes; and,

Step 5) washing the filer cakes obtained in Step 4 using the aqueous solution of ammonium chlorate or ammonium chloride for exchange so as to remove the free metallic ions like sodium, potassium and ferric ions.

Furthermore, according to the preparation process of the petroleum hydrocarbon catalyst, the porous inorganic material further contains the crystalline aluminosilicate structure;

the crystalline aluminosilicate structure is of Y zeolite, MFI zeolite or mixture of the Y zeolite and MFI zeolite; and

the MFI zeolite is ZSM-5.

The present invention provides the method for synthesis of the porous inorganic material, catalytic cracking of petroleum hydrocarbons and preparation of the catalyst thereof. The process for synthesizing the porous inorganic material is advantaged in low material cost; the porous inorganic material contains hierarchical pore structures; the use of the transitional metal overcomes the defects of the catalytic properties, so the porous inorganic material can be used to prepare the catalyst, enrich and develop the properties of the existing catalysts. The porous inorganic material prepared by the method provided by the present invention contains the crystalline aluminum silicate zeolite structure and can ensure surface acidity required for the catalytic reaction of the catalyst. The transitional metal ions are brought into the material, so the surface acidity of the material can be more flexibly adjusted, better satisfy the needs of the catalytic reaction, and is more proper in the catalytic process needing the acid catalytic active site and metal catalytic active site. In additional, besides the crystalline aluminum silicate structure, the porous inorganic material prepared by the method provided by the present invention also contains a great number of meso-pore and macro-pore structures, so the open pores of the catalytic material are distributed with diversity and can meet the diffusion needs of the feedstock molecules in the catalytic reaction, improve the accessibility of the active center of the zeolite structure to further enhance the reaction efficiency and benefits, and reduce negative effects caused by diffusion limit.

The porous inorganic material that serves as the main active ingredient and has the crystalline aluminum silicate zeolite structure can provide the surface acidity required by the catalytic reactions. The transitional metal ions are brought into the material, so the surface acidity of the material can be more flexibly adjusted and can better meet the demands of the cracking reaction of the petroleum hydrocarbons. The catalyst also includes a great number of middle-sized pores and large-sized pores, so the versatile pores of the catalyst are more widely applied and can meet the diffusion needs of the feedstock molecules, thus improving the accessibility of the active center in the zeolite structure, further enhancing the reaction efficiency and benefits of the cracking of the petroleum hydrocarbons and reducing the negative effect caused by diffusion.

The preparation process of the cracking catalyst of the petroleum hydrocarbon employs the porous inorganic material, so the manufacturing cost is low and the pore structures are diversified. The use of the metal iron overcomes the defects of the catalytic properties, further enriches and improves the properties of the catalyst. The porous inorganic material contains the crystalline aluminum silicate zeolite structure, which can provide the surface acidity required by the catalytic reactions. The transitional metal ions are brought into the material, so the surface acidity of the material can be more flexibly adjusted and can better meet the demands of the cracking reaction of the petroleum hydrocarbons. The catalyst also includes a great number of middle-sized pores and large-sized pores, so the ducts of the catalyst are more widely applied and can meet the diffusion needs of the raw material molecules, thus improving the accessibility of the active center in the zeolite structure, further enhancing the cracking reaction efficiency and benefits of the petroleum hydrocarbons and reducing the negative effect caused by diffusion.

The catalytic cracking catalyst of the present invention contains the zeolite ingredients from the kaolin in-situ crystallization device, in comparison with the current zeolite catalytic cracking catalysts of petroleum hydrocarbons, has higher activity and activity stability.

### BRIEF DESCRIPTION OF THE SEVERAL VIEWS OF THE DRAWINGS

FIG. 1 is a flowchart of synthesis process of the porous inorganic material provided by the embodiment of the present invention.

FIG. 2 is a flowchart of catalytic cracking process of petroleum hydrocarbons provided by the embodiment of the present invention.

FIG. 3 is a flowchart of the preparation process of the catalytic cracking catalyst of petroleum hydrocarbons provided by the embodiment of the present invention.

### DETAILED DESCRIPTION OF THE INVENTION

To clarify the objectives, technical solution and advantages of the present invention, the present invention is described in further detail with reference to the following embodiments. It should be understood that the embodiments depicted here are only illustrative, and do not limit the present invention.

The application principle of the present invention is described in further detail with reference to the attached drawings and embodiments.

In this embodiment of the present invention, the method for synthesis of the porous inorganic material, catalytic cracking of petroleum hydrocarbons and preparation of the catalyst thereof includes: synthesis process of the porous inorganic material, catalytic cracking process of petroleum hydrocarbons and preparation of the catalytic cracking catalyst of petroleum hydrocarbons.

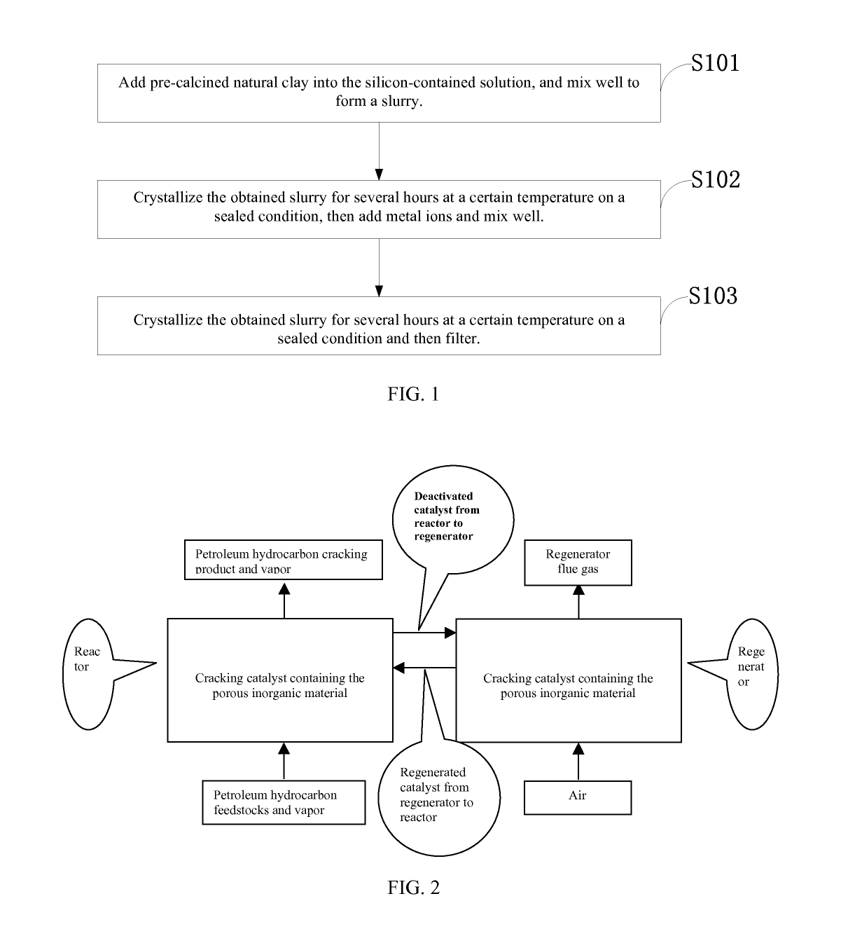

As shown in FIG. 1, the synthesis process of the porous inorganic material provided by the embodiment of the present invention includes the following steps:

S101: adding pre-calcined natural clay into the silicon-contained solution, and mix well to form a slurry;

S102: crystallizing the obtained slurry for several hours at a certain temperature in a sealed condition, then add metal ions and mix well;

S103: further crystallizing the obtained slurry for several hours at a certain temperature in a sealed condition and then filter.

By employing the method of the present invention, the porous inorganic material with a specific surface of 70˜700 m2/g can be obtained, which can have different framework structures according to the synthesis conditions.

The specific steps of the present invention are:

Step 1) calcinating natural clay for 0.5-5 h at a temperature of 500˜1,000° C.;

Step 2) adding the calcined clay into the silicon-containing solution, and mixing well;

Step 3) keeping the obtained slurry on standing at room temperature for 12-48 h, crystallizing 10-48 h at a temperature of 70˜150° C., then adding metal ions and mixing well;

Step 4) crystallizing the obtained slurry for 10-48 h at a temperature of 90˜250° C. in a sealed conditioning, and filtering the slurry to obtain filer cakes;

Step 5) oven drying the obtained filer cakes to obtain the porous inorganic material.

In Step 1, the natural clay is kaolinite, montmorillonite or illite; the content of the aluminium oxide in the kaolinite, montmorillonite and illite is 20%˜50%; the calcinating temperature of the natural clay is preferably 700˜850° C., and the calcinating time is preferably 1-4 h;

In Step 2, the silicon-contained solution is water glass; the modulus of the water glass is 1.0˜4.0.

In Step 3, the metal ions include iron, cobalt and nickel ions; the pH value of the slurry is greater than 7.

The porous inorganic material of the present invention contains the crystalline aluminum silicate zeolite structure, and the crystalline aluminum silicate zeolite is of Y zeolite, ZSM-5 zeolite or mixture of the Y zeolite and ZSM-5 zeolite.

The process provided by the present invention includes the following steps:

(1) calcinating the natural clay such as the kaolinite for 0.5-5 h at a temperature of 500° C.˜1,100° C., preferably 1-4 h at a temperature of 700° C.˜850° C.;

(2) adding the clay processed in step (1) into the silicon-contained solution, preferably water glass solution, mixing well, and controlling the pH value of the slurry to be greater than 7.0;

(3), keeping the slurry obtained in step (2) landing for 12-48 h at room temperature, then crystallizing the slurry for 10-48 h at a temperature of 90° C.˜150° C. in a sealed condition, next adding metal ions into the slurry, preferably iron, cobalt and nickel ions, and stirring the mixed solution well;

(4), re-crystallizing the slurry obtained in step (3) for 10-48 h at a temperature of 90˜250° C. in a sealed conditioning, and filtering the slurry to obtain filer cakes; and,

(5), oven drying the filter cakes obtained in step (4) to obtain the porous inorganic material of the present invention.

In the process provided by the present invention, the purpose of calcinating the natural clay such as the kaolinite at a high temperature is to activate the aluminum element in the clay and make the aluminum element soluble such that the aluminum element can be devoiced from the clay structure in the subsequent processing. In this way, the obtained inorganic material has a relatively large pore capacity. The natural clays vary with properties, so special consideration shall be made during determination of the calcinating activation conditions.

Meanwhile, the active aluminum element obtained through calcinating activation treatment can be combined with the silicon element in the slurry in the subsequent crystallizing process to form the crystalline aluminum silicate zeolite structure; those crystalline aluminum silicate zeolites may be Y zeolites, ZSM-5 zeolites or mixtures of the two, wherein the silicon-aluminum ratio of the Y zeolites is 4.4˜6.0 and that of the ZSM-5 is 20˜200; transitional metal elements are brought into the crystallizing synthesis process, and some transitional metal elements enter the inner ducts of the zeolites to form structural metal which is tightly combined with the zeolites, and the content of those metal elements is in the range of 0%˜15%.

In the process provided by the present invention, the silicon-contained solution is water glass, and its concentration is determined according to the zeolite type and crystallinity in the porous material to be synthesized and can be adjusted within a relatively large scope; to synthesize the porous material with a high zeolite content, more silicon is added, and then the concentration of the water glass is high; to synthesize the porous material containing ZSM-5, a large silicon source is required, and the concentration of the water glass is relatively high; on the contrary, to synthesize the porous material with a relatively low zeolite crystallinity and high large- and middle-sized pore volumes, the concentration of the water glass is relatively low.

In the process provided by the present invention, metal ions are added into the system in the form of hydrated oxides during crystallization. Those hydrated oxides such as the ferric oxide hydrate are obtained through adding alkaline reagents such as ammonia water in the aqueous solution of ferric nitrate while stirring quickly to generate super-thin precipitates and then filtering the precipitates. To ensure that the metal ions effectively enter the inner cages of the zeolites, the metallic oxide hydrates and the slurry for synthesizing the porous materials shall be mixed well.

The process provided by the present invention does not need a template agent. The present invention prolongs the crystallizing time, so the metal ions can fully enter the micropores of the aluminum silicate zeolites.

To meet the requirements for preparation of industrial catalysts, the above porous material needs washing for several times to remove the sodium ions and other elements which do not take part in the synthesis reaction, for example the excessive metal ions added in the middle stage, activated aluminum ions in the clay that do not form the crystalline aluminum silicate.

The following are further descriptions of the application effectiveness of the synthesis process of the porous inorganic material of the present invention with reference to the embodiments of the present invention:

### Embodiment 1

Weigh 50 g Kaolinite (dry basis) of which the composition can be seen in table 1. Calcine it for 4.5 h at a temperature of 550° C. Prepare 400 ml water glass solution with a modulus of 1.5. Add the calcined kaolinite into the water glass solution. Stir the two materials fully and keep them standing for 24 h at room temperature to form a slurry. Place the slurry in a sealed container and crystallize it for 32 h at a temperature of 75° C. Add 8.2 g prepared ferric oxide hydrate (based on ferric oxide) into the slurry. Stir the slurry to mix the iron and other ingredients well. Re-crystallize slurry for 28 h at a temperature of 95° C. in a sealed condition. Naturally cool the slurry to room temperature. Open the container. Filter the slurry and flush for 5 times with the washing water to obtain the porous inorganic material of which the chemical composition and structural parameters can be seen in table 2.

### Embodiment 2

Weigh 50 g montmorillonite (dry basis) of which the composition can be seen in table 1. Calcine it for 2.5 h at a temperature of 750° C. Prepare 500 ml water glass solution with a modulus of 2.0. Add the calcined montmorillonite into the water glass solution. Mix the two materials well and then keep them on standing for 42 h at room temperature to form a slurry. Place the slurry in a sealed container and crystallize it for 40 h at a temperature of 85° C. Add 5.5 g prepared cobalt oxide hydrate (based on cobalt oxide) into the slurry. Stir the slurry to mix the cobalt and other ingredients well. Re-crystallize the slurry for 36 h at a temperature of 95° C. in a sealed condition. Naturally cool the slurry to room temperature. Open the container. Filter the slurry and flush for 5 times with the washing water to obtain the porous inorganic material of which the chemical composition and structural parameters can be seen in table 2.

### Embodiment 3

Weigh 50 g illite (dry basis) of which the composition can be seen in table 1. Calcine it for 3 h at a temperature of 600° C. Prepare 900 ml water glass solution with a modulus of 2.2. Add the calcined illite into the water glass solution. Mix the two materials well and then keep the mixed material on standing for 15 h at room temperature to form a slurry. Place the slurry in a sealed container and crystallize it for 45 h at a temperature of 140° C. Add 3.0 g prepared nickel oxide hydrate (based on nickel oxide) into the slurry. Stir the slurry to mix the nickel and other ingredients well. Re-crystallize the slurry for 46 h at a temperature of 205° C. in a sealed condition. Naturally cool the slurry to room temperature. Open the container. Filter the slurry and flush for 5 times with the washing water to obtain the porous inorganic material of which the chemical composition and structural parameters can be seen in table 2.

### Embodiment 4

Weigh 50 g montmorillonite (dry basis) of which the composition can be seen in table 1. Calcine for 2.5 h at a temperature of 750° C. Prepare 1,000 ml water glass solution with a modulus of 2.8. Add the calcined montmorillonite into the water glass solution. Mix the two materials well and then keep the mixed material on standing for 38 h at room temperature to form slurry. Place the slurry in a sealed container and crystallize it for 20 h at a temperature of 125° C. Add 4.5 g prepared cobalt oxide hydrate (based on cobalt oxide) into the slurry. Stir the slurry to mix the cobalt and other ingredients well. Re-crystallize the slurry for 40 h at a temperature of 220° C. in a sealed condition. Naturally cools the slurry to room temperature. Open the container. Filter the slurry and flush for 5 times with the washing water to obtain the porous inorganic material of which the chemical composition and structural parameters can be seen in table 2.

### Embodiment 5

Weigh 50 g Kaolinite (dry basis) of which the composition can be seen in table 1 is weighed. Calcine it for 2.0 h at a temperature of 800° C. Prepare 1,000 ml water glass solution with a modulus of 2.5. Add the calcined kaolinite into the water glass solution. Stir the slurry to mix the two materials well and then keep the mixture on standing for 24 h at room temperature to form slurry. Place the slurry in a sealed container and crystallize it for 32 h at a temperature of 95° C. Add 4.8 g prepared ferric oxide hydrate (based on ferric oxide) and mix the iron and other ingredients well. Re-crystallize the slurry for 35 h at a temperature of 150° C. in a sealed condition. Naturally cool the slurry to room temperature. Open the container. Filter the slurry and flush for 5 times with the washing water to obtain the porous inorganic material of which the chemical composition and structural parameters can be seen in table 2.

TABLE 1
Composition and material properties

| | | Embodiment | | Embodiment | |
|---|---|---|---|---|---|
| | Embodiment | 2 | Embodiment | 4 | Embodiment |
| | 1 Kaolinite | Montmorillonite | 3 Illite | Montmorillonite | 5 Kaolinite |
| Aluminum | 42.4 | 28.2 | 26.8 | 31.1 | 43.5 |
| oxide, weight % | | | | | |
| Silica oxide, | 54.7 | 67.6 | 68.8 | 64.8 | 55.3 |
| weight % | 2.6 | 1.8 | 2.4 | 2.3 | 1.5 |
| wherein, quartz, | | | | | |
| weight % | | | | | |
| Sodium oxide, | 0.4 | 0.4 | 0.3 | 0.3 | 0.2 |
| weight % | | | | | |
| Potassium oxide, | 0.5 | 0.1 | 0.1 | 0.5 | 0.1 |
| weight % | | | | | |
| Ferric oxide, | 1.2 | 1.4 | 0.9 | 0.6 | 0.4 |
| weight % | | | | | |
| Others, weight % | 0.8 | 2.3 | 3.1 | 2.7 | 0.5 |
| Specific surface | 35 | 58 | 47 | 52 | 25 |
| area, m²/g | | | | | |
| Average particle | 1.0 | 2.6 | 1.5 | 3.5 | 1.0 |
| size, μm | | | | | |

TABLE 2
Chemical composition and structural parameters of porous inorganic material:

| | Embodiment | Embodiment | Embodiment | Embodiment | Embodiment |
|---|---|---|---|---|---|
| | 2 | 2 | 3 | 4 | 5 |
| Aluminum oxide, | 27.2 | 20.2 | 20.9 | 22.6 | 26.3 |
| weight % | | | | | |
| Silica oxide, | 58.3 | 72.1 | 76.1 | 73.1 | 67.5 |
| weight % | | | | | |
| Sodium oxide, | 0.3 | 0.3 | 0.3 | 0.3 | 0.3 |
| weight % | | | | | |
| Ferric oxide, | 11.2 | 0.6 | 0.5 | 2.6 | 4.1 |
| weight % | | | | | |
| Cobalt oxide, | — | 6.4 | — | — | — |
| weight % | | | | | |
| Nickel oxide, | — | — | 1.3 | — | — |
| weight % | | | | | |
| Others, weight % | 3.0 | 0.4 | 0.9 | 1.4 | 1.8 |
| Cell constant, nm | 2.468 | 2.466 | — | — | 2.466 |
| Crystallinity, % | 65 | 10 | — | — | 36 |
| Specific surface | 550 | 180 | 204 | 195 | 259 |
| area, m²/g | | | | | |
| Average particle | 1.2 | 2.9 | 1.6 | 3.5 | 1.3 |
| size, μm | | | | | |

As shown in FIG. 2, the catalytic cracking process of the petroleum hydrocarbons provided by the embodiment of the present invention includes the following steps:

the petroleum hydrocarbons and the catalyst contact each other at a temperature of 460˜680° C. with existence of vapor; the catalyst-to-oil ratio is 4˜40 (weight/weight); the vapor is 1%˜80% of the petroleum hydrocarbon weight; by weight percentage, the catalyst includes 10%˜70% of porous inorganic material, 0%˜50% of kaolin, 0%˜30% of pseudo-boehmite, 0%˜15% of silicon-contained sol and 0%˜30% of aluminum sol;

the petroleum hydrocarbons include vacuum gas oil, atmospheric residual oil, vacuum residue, coker gas oil, hydrogenated oils of those distillates;

the petroleum hydrocarbons have a carbon residue content of 0%˜9.0% and a density of 0.85˜0.99 g/ml;

the contact temperature is preferably 470˜550° C.; the catalyst-oil ratio is preferably 4˜12 on weight basis; the dose of the vapor is preferably 10%˜70% of the petroleum hydrocarbons weight.

The preparation of the catalyst includes steps: mixing the pseudo-boehmite slurry, silicon-contained sol, aluminum sol, porous inorganic material slurry and kaolin slurry well to form catalyst slurry, spray forming, drying, exchanging with rare earth, washing, drying, calcinating in hydrothermal atmosphere, wherein the silicon-containing sol is water glass solution with a modulus of 2.9˜3.2 and a solid content of 5%˜15% weight; the catalyst includes the following ingredients in weight percentage: 10%˜70% of porous inorganic material, 0%˜60% of kaolin, 0%˜30% of pseudo-boehmite, 0%˜15% of silicon-contained sol and 0%˜30% of aluminum sol;

the content of the porous inorganic material is preferably 30%˜60%; the content of the kaolin is preferably 20%˜40%; the content of the pseudo-boehmite is preferably 10%˜20%; the content of the aluminum sol is preferably 5%˜25%;

the kaolin is calcined to be activated, then mixed well with the water glass solution, kept on standing, crystallized, added with metal oxides such as ferric oxides, re-crystallized, washed and exchanged, wherein the porous inorganic material contains the Y zeolite structure, ZSM-5 zeolite structure or mixture of those two structures.

The process provided by the present invention includes contact between the petroleum hydrocarbons and a catalyst, wherein the contact is implemented in a vapor atmosphere; the contact conditions includes 460˜680° C. temperature and 4˜40 catalyst-to-oil ratio, and the vapor accounts for 1%˜80% of the weight of the petroleum hydrocarbons;

The catalyst includes the following ingredients in weight percentage: 10%˜70% of porous inorganic material, 0%˜60% of kaolin, 0%˜30% of pseudo-boehmite, 0%˜15% of silicon-contained sol and 0%˜30% of aluminum sol.

The preparation of the catalyst includes steps of: mixing the pseudo-boehmite slurry, silicon-contained sol, aluminum sol, porous inorganic material slurry and kaolin slurry well to form catalyst slurry, spray-forming (drying, exchanging with rare earth, washing, drying, calcinating in a hydrothermal atmosphere, wherein the silicon-contained sol is water glass solution with a modulus of 2.9˜3.2 and a solid content of 5%˜15%.

The preparation process of the porous inorganic material comprises the following steps:

calcinating to activate the kaolin, then mixing with the water glass solution well, keeping the mixed material standing, crystallizing the mixed material, adding metal oxides such as ferric oxides, re-crystallizing the mixture, washing the mixture and implementing exchange, wherein the porous inorganic material contains the Y zeolite structure, ZSM-5 zeolite structure or mixture of those two structures. During synthesis, metals are brought into the inner structure of the crystalline aluminum silicate, thus greatly improving the performance of the porous inorganic materials; the clay is used as the main raw material, so the preparation cost is also very low.

The chemical composition and structural parameters of the porous inorganic material prepared by the method of the present invention can be seen in table 3, and the physical and chemical properties of the catalyst can be seen in table 4. Samples with contrast to the present invention catalyst are manufactured by using the same procedure of the present invention, but substituting the porous inorganic material with the kaolin or montmorillonite and Y zeolite or ZSM-5 zeolite or mixture of the Y zeolite and ZSM-5 zeolite according to the composition of the porous inorganic material, and the physical and chemical properties of these contrast catalysts can be seen in table 5,

TABLE 3
Chemical composition and structural parameters
of porous inorganic material

| | Code of porous inorganic material | |
|---|---|---|
| | MHY | MHZ |
| Aluminum oxide, weight % | 27.0 | 22.3 |
| Silica oxide, weight % | 58.6 | 73.3 |
| Sodium oxide, weight % | 0.3 | 0.3 |
| Ferric oxide, weight % | 11.0 | 2.1 |
| Others, weight % | 3.1 | 1.3 |
| Cell constant | 2.466 | — |
| Crystallinity, % | 68 | — |
| Specific surface area, m²/g | 560 | 228 |
| Average particle size, μm | 1.3 | 3.1 |

TABLE 4
Physical and chemical properties of the catalyst samples

| | Code of catalyst | | |
|---|---|---|---|
| | C-1 | C-2 | C-3 |
| Aluminum oxide, weight % | 49.2 | 49.0 | 62.6 |
| Silica oxide, weight % | 45.3 | 48.8 | 31.3 |
| Sodium oxide, weight % | 0.2 | 0.1 | 0.2 |
| Ferric oxide, weight % | 1.7 | 1.0 | 3.4 |
| Rare earth oxide, weight % | 2.2 | — | 1.4 |
| Others, weight % | 1.4 | 1.1 | 2.1 |
| Average particle size, μm | 68.5 | 74.5 | 77.9 |
| Cell constant^{a)}, nm | 2.456 | — | 2.443 |
| Crystallinity^{a)}, % | 8 | — | 22 |
| Specific surface area^{a)}, m²/g | 205 | 225 | 281 |
| Pore size^{a)}, ml/g | 0.39 | 0.39 | 0.41 |
| Apparent bulk density^{a)}, g/ml | 0.74 | 0.73 | 0.70 |
| Cell constant^{b)}, nm | 2.430 | — | 2.432 |
| Crystallinity^{b)}, % | 6 | — | 15 |
| Specific surface area^{b)}, m²/g | 88 | 112 | 129 |
| Pore size^{b)}, ml/g | 0.26 | 0.28 | 0.29 |
| Apparent bulk density^{b)}, g/ml | 0.87 | 0.85 | 0.84 |
| Micro activity^{b)}, weight % | 63 | 49 | 59 |

^{a)}Fresh catalyst;
^{b)}Catalyst aged for 24 h at a temperature of 790° C. with existence of 100% vapor;

TABLE 5
Physical and chemical properties of the contrast catalyst samples

| | Code of catalyst | | |
|---|---|---|---|
| | C^{/}-1 | C^{/}2 | C^{/}-3 |
| Aluminum oxide, | 49.2 | 49.3 | 63.1 |
| weight % | | | |
| Silica oxide, weight % | 46.3 | 48.8 | 33.5 |
| Sodium oxide, weight % | 0.2 | 0.2 | 0.2 |
| Ferric oxide, weight % | 0.8 | 0.3 | 0.3 |
| Rare earth oxide, | 2.2 | — | 1.7 |
| weight % | | | |
| Others, weight % | 1.3 | 1.4 | 1.2 |
| Average particle size, | 73.1 | 72.2 | 75.1 |
| μm | | | |
| Cell constant^{a)}, nm | 2.458 | — | 2.446 |
| Crystallinity^{a)}, % | 7 | — | 19 |
| Specific surface area^{a)}, | 199 | 221 | 270 |
| m²/g | | | |
| Pore size^{a)}, ml/g | 0.39 | 0.40 | 0.41 |
| Apparent bulk density^{a)}, | 0.75 | 0.73 | 0.71 |
| g/ml | | | |
| Cell constant^{b)}, nm | 2.427 | — | 2.427 |
| Crystallinity^{b)}, % | 4 | — | 9 |
| Specific surface area^{b)}, | 65 | 90 | 100 |
| m²/g | | | |
| Pore size^{b)}, ml/g | 0.22 | 0.25 | 0.24 |
| Apparent bulk | 0.90 | 0.88 | 0.88 |
| density^{b)}, g/ml | | | |
| Micro activity^{b)}, weight | 54 | 33 | 45 |
| % | | | |

^{a)}Fresh catalyst;
^{b)}Catalyst aged for 24 h at a temperature of 790° C. with existence of 100% vapor;

According to the catalytic cracking process of the petroleum hydrocarbons provided by the present invention, the petroleum hydrocarbons include various petroleum distillates, for example: vacuum gas oil, atmospheric residual oil, vacuum residual oil and coker gas oil;

the vacuum gas oil has a density of 0.86˜0.95 g/cm³ at a temperature of 20° C., a freezing point of 30˜45° C., a carbon weight content of 86.05%˜86.60%, a hydrogen weight content of 11.89%˜13.56%, carbon residue of 0.09%˜0.45% on weight basis, an initial boiling point of 295˜370° C.; and the 95% distillate recovery temperature is 515˜540° C.;

the atmospheric residual oil has a density of 0.8980˜0.9850 g/cm3 at a temperature of 20° C., a freezing point of 35˜50° C., a carbon weight content of 86.10%˜86.65%, a hydrogen weight content of 11.90%˜13.05%, a sulphur weight content of 0.10%˜1.50%, a nitrogen weight content of 0.20%˜0.60%, a carbon residue of 5.15%˜9.02% on weight basis, an iron content of 0.7˜12.5 ppm weight, a nickel content of 1.0˜13.5 ppm weight, a vanadium content of 0.1˜8.0 ppm weight, a calcium content of 0.5˜15.0 ppm weight, and a sodium content of 1.0˜5.0 ppm weight;

the vacuum residual oil has a density of 0.9250˜1.0150 g/cm³ at a temperature of 20° C., a freezing point of over 40° C., a carbon weight content of 86.15%˜86.70%, a hydrogen weight content of 11.15%˜12.50%, a sulphur weight content of 0.20%˜2.50%, a nitrogen weight content of 0.30%˜0.80%, a carbon residue of 7.50%˜15.50% on weight basis, an iron content of 1.0˜18.5 ppm weight, a nickel content of 1.0˜15.5 ppm weight, a vanadium content of 0.5˜12.0 ppm weight, a calcium content of 0.5˜25.0 ppm weight, and a sodium content of 2.0˜8.0 ppm weight;

the coker oil gas has a density of 0.8850˜0.9400 g/cm³ at a temperature of 20° C., a freezing point of 20%-40° C., an initial boiling point of 310˜350° C., a carbon residual of 0.2%˜0.9% weight, a carbon weight content of 84.20%˜86.50%, a hydrogen weight content of 10.50%˜11.90%, a sulphur weight content of 0.30%˜4.50%, a nitrogen weight content of 0.30%˜0.70%, a saturated hydrogen carbon of 50%˜70% weight, an aromatic hydrocarbon of 20%˜40% weight, a resin content of 5%˜15% weight, and does not contain asphalt.

According to the method provided by the present invention, the petroleum hydrocarbons include various hydrogenated petroleum distillates, such as the hydrogenated vacuum gas oil, hydrogenated atmospheric residual oil, hydrogenated vacuum residual oil and hydrogenated coker gas oil. In terms of product distribution, more flexible yield patterns can be realized, such as maximized yield of gasoline, diesel oil or light olefins.

The following are further descriptions of the application effectiveness of the synthesis process of the porous inorganic material of the present invention with reference to the embodiments of the present invention:

The physical and chemical properties of the vacuum gas oil, atmospheric residual oil, vacuum residual oil and coker gas oil used in the embodiments are listed in table 6, and those of the hydrogenated oils listed in table 7.

### Embodiments 1-6

The petroleum hydrocarbons as shown in table 6 and table 7 are weighted and mixed to form the required feedstock oil according to the ratio as shown in table 8. The catalyst as shown in table 4 is used to prepare the catalyst samples of the embodiments according to the mixing ratios as shown in table 9.

The catalyst samples in embodiments 1-6 are aged for 8 h at a temperature of 800° C. in a 100% vapor atmosphere. On the lab-scale fixed fluidized-bed reactor, the aged catalysts are respectively evaluated by the catalytic cracking of the petroleum hydrocarbon feedstock oils as shown in table 8, wherein the catalyst loading amount is 500 g; the reaction temperature is 480˜640° C.; the catalyst-to-oil ratio is 4˜20 weight; the vapor accounts for 10%˜60% of the weight of the petroleum hydrocarbon. The specific conditions of the catalytic cracking evaluation can be seen in table 10, and the catalytic cracking reaction results can be seen in table 11.

Contrast Samples 1-6:

The petroleum hydrocarbons as shown in table 6 and table 7 are weighted and mixed to form the required hydrocarbon feedstock oil according to the ratio as shown in table 8. The catalyst as shown in table 5 is used to prepare the catalyst samples of the contrast examples according to the mixing ratios as shown in table 12.

On corresponding conditions of the embodiments, as shown in table 10, contrast tests were carried out. The catalytic cracking results of the petroleum hydrocarbon feedstocks in the embodiments can be seen in table 11. The mixing ratios of the catalyst samples in the contrast examples can be seen in table 12. The catalytic cracking reaction results of contrast samples are listed in table 13. From tables 11 and table 13, it can be seen that the method of the present invention has high petroleum hydrocarbon catalytic cracking activity and selectivity, high additional values, high yield, and high gasoline octane numbers.

TABLE 6
Properties of the vacuum gas oil, atmospheric residual oil, vacuum
residual oil and coker as oil

| | Type of the petroleum hydrocarbon | | | |
|---|---|---|---|---|
| | Vacuum | Atmospheric | Vacuum | Coker gas |
| | gas oil | residual oil | residual oil | oil |
| Density @20° C., g/cm³ | 0.8830 | 0.9420 | 0.9928 | 0.9350 |
| Viscosity @100° C., | 8.90 | 80.2 | 1290 | 6.0 |
| mm²/s | | | | |
| Freezing point, ° C. | 38 | 40 | 52 | 30 |
| Carbon residue, | 0.23 | 8.83 | 12.90 | 0.81 |
| weight % | | | | |
| Element analysis, | | | | |
| weight % | | | | |
| Carbon | 86.29 | 86.12 | 86.21 | 84.75 |
| Hydrogen | 12.60 | 11.90 | 11.18 | 11.14 |
| Sulphur | 0.64 | 1.10 | 1.50 | 3.50 |
| Nitrogen | 0.27 | 0.58 | 0.72 | 0.40 |
| Metal weight content, | | | | |
| ppm | | | | |
| Nickel | — | 8.9 | 12.1 | — |
| Vanadium | — | 5.1 | 6.9 | — |
| Iron | — | 10.5 | 15.5 | — |
| Calcium | — | 3.3 | 5.3 | — |
| Sodium | — | 2.2 | 3.8 | — |
| Boiling range, ° C. | | | | |
| Initial boiling point | 367 | — | — | 335 |
| 95% Distillate | 529 | — | — | — |
| End boiling point | — | — | — | 495 |

TABLE 7
Properties of the hydrogenated vacuum gas oil, atmospheric residual
oil, vacuum residual oil and coker gas oil in the embodiments

| | Type of the petroleum hydrocarbon | | | |
|---|---|---|---|---|
| | | | Hydro- | |
| | Hydro- | | genated | Hydro- |
| | genated | Hydrogenated | vacuum | genated |
| | vacuum | atmospheric | residual | coker |
| | gas oil | residual oil | oil | gas oil |
| Density | 0.8702 | 0.9420 | 0.9870 | 0.9155 |
| @20° C., | | | | |
| g/cm³ | | | | |
| Viscosity | 4.90 | 60.2 | 495 | 2.0 |
| @100° C., | | | | |
| mm²/s | | | | |
| Freezing | 18 | 30 | 41 | 20 |
| point, ° C. | | | | |
| Carbon | 0.02 | 5.83 | 6.75 | 0.12 |
| residue, | | | | |
| weight % | | | | |
| Element | | | | |
| analysis, | | | | |
| weight % | | | | |
| Carbon | 86.29 | 85.82 | 86.52 | 85.51 |
| Hydrogen | 13.10 | 12.90 | 12.21 | 12.70 |
| Sulphur | 0.24 | 0.50 | 0.70 | 1.30 |
| Nitrogen | 0.07 | 0.28 | 0.32 | 0.10 |
| Metal weight | | | | |
| content, ppm | | | | |
| Nickel | — | 2.9 | 4.1 | — |
| Vanadium | — | 1.6 | 3.3 | — |
| Iron | — | 2.5 | 5.2 | — |
| Calcium | — | 1.4 | 2.9 | — |
| Sodium | — | 1.2 | 1.5 | — |
| Boiling range, | | | | |
| ° C. | | | | |
| Initial boiling | 357 | — | — | 325 |
| point | | | | |
| 95% Distillate | 513 | — | — | — |
| End boiling | — | — | — | 477 |
| point | | | | |

TABLE 8
Mixing ratios of petroleum hydrocarbons of feedstock oils in the
embodiments and contrast examples

| | Embodiment No. | | | | | |
|---|---|---|---|---|---|---|
| | 6 | 7 | 8 | 9 | 10 | 11 |
| | Contrast Example No. | | | | | |
| | 1 | 2 | 3 | 4 | 5 | 6 |
| Vacuum gas oil, weight % | 100 | | | | | 55 |
| Atmospheric residual oil, | | | 100 | | | 30 |
| weight % | | | | | | |
| Vacuum residual oil, | | | | | | 15 |
| weight % | | | | | | |
| Coker residual oil, weight % | | | | | 20 | |
| Hydrogenated vacuum gas | | 100 | | | | |
| oil, weight % | | | | | | |
| Hydrogenated atmospheric | | | | 70 | | |
| residual oil, weight % | | | | | | |
| Hydrogenated vacuum | | | | | 80 | |
| residual oil, weight % | | | | | | |
| Hydrogenated coker residual | | | | 30 | | |
| oil, weight % | | | | | | |
| Total, weight % | 100 | 100 | 100 | 100 | 100 | 100 |

TABLE 9
Accurate mixing ratios of catalyst in the embodiments

| | Embodiment No. | | | | | |
|---|---|---|---|---|---|---|
| | 6 | 7 | 8 | 9 | 10 | 11 |
| C-1, weight % | 100 | | | 60 | | 25 |
| C-2, weight % | | 100 | | 40 | 30 | |
| C-3, weight % | | | 100 | | 70 | 75 |
| Total, weight % | 100 | 100 | 100 | 100 | 100 | 100 |

TABLE 10
Evaluation conditions of catalytic cracking reactions of the petroleum
hydrocarbons

| | Embodiment No. | | | | | |
|---|---|---|---|---|---|---|
| | 6 | 7 | 8 | 9 | 10 | 11 |
| | Contrast Example No. | | | | | |
| | 1 | 2 | 3 | 4 | 5 | 6 |
| Reaction temperature, ° C. | 500 | 620 | 510 | 545 | 585 | 520 |
| Weight hour space velocity | 12 | 20 | 12 | 16 | 16 | 12 |
| h⁻¹ | | | | | | |
| Catalyst-to-oil ratio, weight/ | 6 | 20 | 7 | 15 | 18 | 9 |
| weight | | | | | | |
| Vapor/feedstock oil, weight % | 12 | 50 | 15 | 30 | 45 | 20 |

TABLE 11
Catalytic cracking reaction results of the petroleum hydrocarbons in the
embodiments

| | Embodiment No. | | | | | |
|---|---|---|---|---|---|---|
| | 6 | 7 | 8 | 9 | 10 | 11 |
| Yield, weight % | | | | | | |
| Dry gas | 2.2 | 10.3 | 2.9 | 2.4 | 5.9 | 2.5 |
| Liquefied petroleum gas | 21.9 | 46.8 | 12.2 | 30.2 | 34.7 | 15.9 |
| Gasoline | 50.2 | 32.5 | 48.9 | 39.5 | 33.0 | 47.5 |
| LCO | 20.1 | 5.0 | 23.0 | 18.0 | 16.0 | 22.1 |
| Heavy oil | 2.1 | 0.6 | 2.5 | 3.1 | 3.5 | 4.6 |
| Coke | 3.5 | 4.8 | 10.5 | 6.8 | 6.9 | 7.4 |
| Total, weight % | 100.0 | 100.0 | 100.0 | 100.0 | 100.0 | 100.0 |
| Conversion, weight % | 77.8 | 94.4 | 74.5 | 78.9 | 80.5 | 73.3 |
| Light oil yield, weight % | 70.3 | 37.5 | 71.9 | 57.5 | 49.0 | 69.6 |
| Total liquid yield | 92.2 | 84.3 | 84.1 | 87.7 | 83.7 | 85.5 |
| (LPG + Gasoline + LCO), | | | | | | |
| weight % | | | | | | |
| Gasoline Octane Number, | 91.2 | 95.7 | 92.1 | 93.5 | 94.2 | 92.8 |
| RON | | | | | | |

TABLE 12
Mixing ratios of catalyst samples in contrast examples

| | Contrast Example No. | | | | | |
|---|---|---|---|---|---|---|
| | 1 | 2 | 3 | 4 | 5 | 6 |
| C^{/}-1, weight % | 100 | | | 60 | | 25 |
| C^{/}-2, weight % | | 100 | | 40 | 30 | |
| C^{/}-3, weight % | | | 100 | | 70 | 75 |
| Total, weight % | 100 | 100 | 100 | 100 | 100 | 100 |

TABLE 13
Catalytic cracking reaction results of the petroleum hydrocarbons in the
contrast examples

| | Contrast example No. | | | | | |
|---|---|---|---|---|---|---|
| | 1 | 2 | 3 | 4 | 5 | 6 |
| Yield, weight % | | | | | | |
| Dry gas | 2.3 | 9.7 | 3.0 | 2.4 | 5.7 | 2.4 |
| Liquefied petroleum gas | 20.4 | 43.3 | 11.3 | 27.4 | 32.2 | 14.0 |
| Gasoline | 49.2 | 32.6 | 47.7 | 40.5 | 33.1 | 47.1 |
| LCO | 20.6 | 7.0 | 22.9 | 18.0 | 16.3 | 22.6 |
| Heavy oil | 3.7 | 2.2 | 4.0 | 4.6 | 5.3 | 6.3 |
| Coke | 3.8 | 5.2 | 11.1 | 7.1 | 7.4 | 7.6 |
| Total, weight % | 100.0 | 100.0 | 100.0 | 100.0 | 100.0 | 100.0 |
| Conversion, weight % | 75.7 | 90.8 | 73.1 | 77.4 | 78.4 | 71.0 |
| Light oil yield, weight % | 69.8 | 39.6 | 70.6 | 58.5 | 49.4 | 69.7 |
| Total liquid yield | 90.2 | 82.9 | 81.9 | 85.9 | 81.6 | 83.7 |
| (LPG + Gasoline + LCO), | | | | | | |
| weight % | | | | | | |
| Gasoline Octane Number, | 91.0 | 94.9 | 91.0 | 92.8 | 93.5 | 92.0 |
| RON | | | | | | |

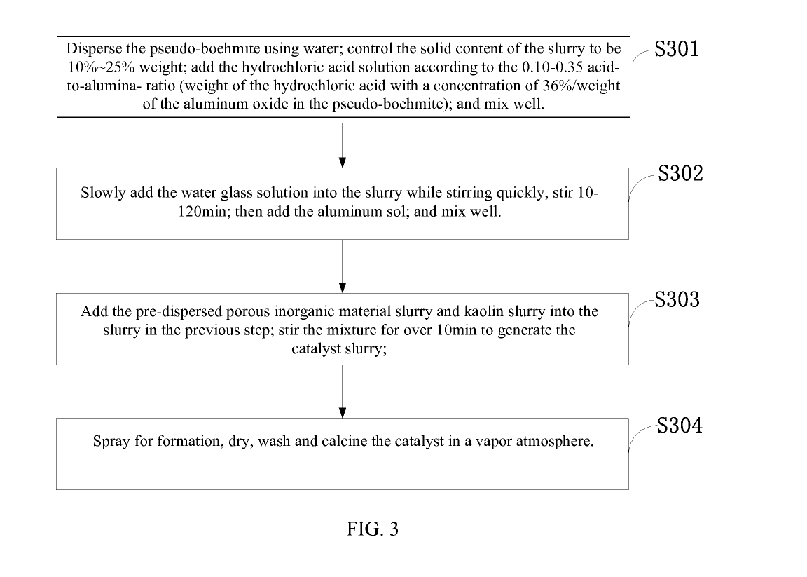

As shown in FIG. 3, the preparation of the cracking catalyst of the petroleum hydrocarbons provided by the embodiment of the present invention includes the following steps:

acidifying the pseudo-boehmite, adding the silicon-contained solution, aluminum solution and one or several porous inorganic materials in sequence, then stirring mixed slurry well, spay-forming, drying, washing and calcinating.

S301: Dispersing the pseudo-boehmite using water; control the solid content of the slurry to be 10%˜25% weight; adding the hydrochloric acid solution according to the 0.10-0.35 aluminum-to-acid ratio (weight of the hydrochloric acid with a concentration of 36%/weight of the aluminum oxide in the pseudo-boehmite); and stirring the mixed materials well;

S302, Slowly adding the water glass solution into the slurry while stirring quickly, stirring for 10-120 min, adding the aluminum sol; and stirring the mixed materials well;

S303, Adding the pre-dispersed porous inorganic material slurry and kaolin slurry into the slurry in the previous step; stirring the mixture for over 10 min to generate the catalyst slurry;

S304, Spray-forming the catalyst slurry, drying, washing and calcinating the slurry in a vapor atmosphere.

According to the preparation process of the petroleum hydrocarbons cracking catalyst, the catalyst comprises the following ingredients by weight percentage: 10%˜70% of porous inorganic material, 0%˜60% of kaolin, 0%˜30% of pseudo-boehmite, 0%˜15% of silicon-contained sol and 0%˜30% of aluminum sol. The preparation process comprises the following steps:

The present invention specifically comprises the following steps:

(1) dispersing the pseudo-boehmite using water; controlling the solid content of the slurry to be 10%˜25% weight; adding the hydrochloric acid solution according to the 0.10-0.35 aluminum-to-acid ratio (weight of the hydrochloric acid with a concentration of 36%/weight of the aluminum oxide in the pseudo-boehmite); and stirring the mixed materials well;

(2) slowly adding the water glass solution into the slurry obtained in step (1) while stirring quickly, followed by stirring for 10-120 min; then adding the aluminum sol; and stirring the mixed materials well;

(3) adding the pre-dispersed porous inorganic material slurry and kaolin slurry into the slurry in step (2); stirring the mixture for over 10 min to generate the catalyst slurry;

(4) spray-forming the catalyst slurry, drying, washing, and calcinating the slurry in a vapor atmosphere.

In steps (1)-(4), the adding sequence of the materials can be adjusted.

The silicon-contained solution used in the present invention is water glass solution with a modulus of 2.9˜3.2. The purpose of importing silicon is to adjust the acidity and pore size distribution of the catalyst matrix such that the catalyst has better petroleum hydrocarbon cracking selectivity.

According to the method provided by the present invention, the porous inorganic material employed is prepared by the following steps:

(1) calcinating the kaolin for 0.5-5 h at a temperature of 500˜1,100° C.;

(2) adding the clay calcined in step (1) into the silicon-contained solution, and mixing well;

(3) keeping the slurry obtained in step (2) on landing for 12-48 h at room temperature, then crystallizing the slurry for 10-48 h at a temperature of 70° C˜150° C. in a sealed condition, next adding ferric oxides into the slurry, and then stirring the mixed slurry well;

(4) re-crystallizing the slurry obtained in step (3) for 10-48 h at a temperature of 90˜250° C. in a sealed conditioning, and filtering the slurry to obtain filer cakes, and oven drying the filter cakes;

(5) washing the filer cakes obtained in step (4) using the aqueous solution of ammonium chlorate or ammonium chloride for exchange so as to remove the free metallic ions like sodium, potassium and ferric ions.

According to the method provided by the present invention, the porous inorganic material employed contains the crystalline aluminum silicate structure. More specifically, such crystalline aluminum silicate structure is Y zeolites, MFI zeolites or a mixture of the two, wherein the MFI zeolites are ZSM-5.

The chemical composition and structural parameters of the porous inorganic material prepared by the method of the present invention can be seen in table 14. Two or more porous inorganic materials are used.

According to the present invention, the spray-formed and dried catalyst is hydrothermally calcined, aiming at that the crystalline aluminum silicate structure in the catalyst is properly dealuminated and ultra-stabilized to further stabilize the structure of the catalyst. This process is applicable to petroleum hydrocarbon cracking catalyst with the following ingredients on weight basis: 10%˜70% of porous inorganic material, 0%˜60% of kaolin, 0%˜30% of pseudo-boehmite, 0%˜15% of silicon-contained sol and 0%˜30% of aluminum sol; the element contents are as follows: the weight of the aluminum oxide accounts for 20%˜70%, and the silica oxide accounts for 30%˜70%; the catalyst of the present invention has a specific surface area of 150˜350 m²/g, a pore volume of 0.20˜0.48 mg/g, qualified attrition-resistant strength and an average particle size of 55˜90 μm.

The application effectiveness of the preparation process of the cracking catalyst of the petroleum hydrocarbons of the present invention are further described with reference to the embodiments of the present invention.

### Embodiment 12

Weigh 20 kg Porous inorganic material MY (dry basis) of which the composition and structural parameters can be seen in Table 1, and add it into 40 kg acidic water. Disperse for 30 min beating to obtain a slurry. Slowly add 4 kg water glass solution (dry basis) with a solid content of 8% weight into the slurry while stirring. Stir the mixed slurry for 20 min. Add 23 kg aluminum sol (dry basis) into the mixed slurry. Stir for 30 min to obtain a mixed slurry. Add 53 kg kaolin slurry (dry basis) with a solid content of 25% weight into the mixed slurry. Stir the mixed slurry for 45 min. Spray the mixed slurry for formation. Exchange with the rare earth solution. Wash and dry the exchanged product. Calcine the dried product at a temperature of 650° C. in a vapor atmosphere for 2 h to obtain the catalyst sample A of which the physical and chemical properties can be seen in table 15.

### Embodiment 13

Weigh 15 kg pseudo-boehmite (dry basis). Add 135 kg water to obtain a mixed material. Stir the mixed material for 20 min. Add 36% hydrochloric acid solution according to the 0.18 acid-to-aluminum ratio. Perform acidification for 40 min with stirring. On condition of strong stirring, add 30 kg porous inorganic material MYZ and 15 kg MZ porous material. Keep stirring for 90 min to obtain a mixed substance. Add 20 kg aluminum sol solution (dry basis) with a solid content of 15% into the mixed substance. Stir for 20 min. Add 12 kg water glass solution (dry basis) with a solid content of 10% weight. Stir for 110 min. Then, add 8 kg kaolin slurry (dry basis) with a solid content of 30% weight to obtain a mixed slurry. Stir the mixed slurry for 60 min. Spray the mixed slurry for formation. Exchange with rare earth solution. Wash and dry the exchanged product. Calcine the dried product for 3 h at a temperature of 600° C. to obtain the catalyst sample B of which the physical and chemical properties can be seen in table 15.

### Embodiment 14

Weigh 5 kg pseudo-boehmite (dry basis). Add 100 kg decationized water to obtain a mixed substance. Stir the mixed substance for 60 min. Add 36% hydrochloric acid solution according to the 0.30 acid-to-aluminum ratio to obtain a mixed solution. Stir the mixed solution for 20 min. Keep the mixed slurry standing for acidification for 60 min to obtain a peptized material. Add 8 kg water glass solution with a solid content of 25% weight into the acidified material with quick stirring to obtain a mixed slurry. Stir the mixture for 49 min. Add 60kg MYZ porous material with a solid content of 30% weight into the mixed slurry. Stir for 30 min. Finally, add 7 kg aluminum sol (dry basis) with a solid content of 10% weight into the material obtained in the previous step. Stir the material for 40 min. Spray-form the product. Wash and dry the product repeatedly. Calcine the dried product for 5 h at a temperature of 550° C. in a vapor atmosphere to obtain the catalyst sample C of which the physical and chemical properties can be seen in table 15.

### Embodiment 15

Weigh 14 kg kaolin (dry basis). Add 30 kg water to obtain a mixed substance. Stir the mixed substance fully. Add 18 kg pseudo-boehmite slurry (dry basis) with a solid content of 15% weight that is prepared in advance according to the 0.25 acid-to-aluminum ratio to obtain a mixed slurry. Stir the mixed slurry for 45 min. Add 18 kg aluminum sol (dry basis) with a solid content of 10% weight that is prepared in advance. Stir for 20 min. Add 50 kg MZ porous material slurry (dry basis) with a solid content of 20% weight that is prepared in advance into the stirred material to obtain a mixed slurry. Strongly stir the mixed slurry for 90 min. Spray for formation. Dry and wash the obtained product for several times. Remove the excessive anions and cations. Then, send the obtained product into a high temperature oven, and calcine product for 4 h at a temperature of 600° C. to obtain the catalyst sample D of which the physical and chemical properties can be seen in table 15.

### Embodiment 16

Weigh 32 kg kaolin (dry basis). Add 160 kg water to form a slurry. Stir and homogenize the kaolin fully. Add 40 kg MYZ porous material (dry basis) into the slurry to obtain a mixed substance. Fully stir the mixed substance. Then, add 10 kg pseudo-boehmite slurry (dry basis) with a solid content of 15% weight that is prepared using hydrochloric acid solution according to the 0.25 acid-to-aluminum ratio in advance into the mixed substance to obtain a slurry. Stir the slurry for 30 min. Add 16 kg aluminum sol (dry basis) with a solid content of 15% weight into the slurry. Stir the obtained slurry for 45 min. Next, add 2 kg water glass solution (dry basis) with a solid content of 10% weight to obtain a mixed material. Stir the mixed material for 90 min. Spray for formation. Exchange with the rare earth solution. Wash and dry the ion-exchanged product. Calcine the dried product for 3 h at a temperature of 620° C. in a vapor atmosphere in a high-temperature oven to obtain a catalyst sample E of which the physical and chemical properties can be seen in table 15.

### Embodiment 17

Weigh 31 kg MZ porous material (dry basis). Add 100 kg water to form a slurry. Stir and homogenize the MZ porous material fully. Add 25 kg pseudo-boehmite slurry (dry basis) which is prepared using 36% hydrochloric acid according to the 0.15 acid-to-aluminum ratio in advance and adjusted using water to have a solid content of 15% weight into the slurry. Stir the slurry for 30 min. Add 40 kg kaolin slurry (dry basis) with a solid content of 20% weight into the slurry. Stir the mixed slurry for 40 min. Next, slowly and uniformly add 4 kg water glass solution (dry basis) with a solid content of 8% weight to obtain a mixed material. Stir the mixed material for 60 min. Spray for formation. Repeatedly wash and dry the obtained product. Ion-exchange with the rare earth solution. Wash and dry the exchanged product. Calcine the dried product for 1 h at a temperature of 620° C. in a vapor atmosphere in a high-temperature oven to obtain a catalyst sample F of which the physical and chemical properties can be seen in table 15.

### Embodiment 18

Weigh 31 kg MY porous material (dry basis) and 24 kg kaolin (dry basis). Add 150 kg water. Disperse for 60 min to obtain slurry. Then, add 20 kg pseudo-boehmite slurry (dry basis) with a solid content of 15% that is prepared according to a 0.15 acid-to-aluminum ratio into the slurry. Stir the mixed slurry for 30 min. Finally, add 25 kg aluminum sol (dry basis) with a solid content of 18% weight. Stir the mixed material well for 50 min. Spray the mixed material for formation. Ion-exchange with the rare earth solution. Wash and dry the exchanged product. Brake the dried product for 3 h at a temperature of 600° C. in a vapor atmosphere in a high-temperature furnace to obtain the catalyst sample G of which the physical and chemical properties can be seen in table 15.

According to the preparation processes of embodiments 12-18 and the composition of the porous materials, contrast catalyst samples are respectively prepared using equivalent amount of kaolin or montmorillonite and the mixture of the Y zeolites and (or:) ZSM-5 zeolites which substitute for the porous materials, correspondingly numbered A/-G/. The physical and chemical properties can be seen in table 16.

TABLE 14
Chemical composition and structural parameters of
porous inorganic material

| Code of porous inorganic material | MY | MZ | MYZ |
|---|---|---|---|
| Aluminum oxide, weight % | 27.1 | 22.7 | 26.4 |
| Silica oxide, weight % | 58.5 | 72.9 | 67.4 |
| Sodium oxide, weight % | 0.3 | 0.3 | 0.3 |
| Ferric oxide, weight % | 11.1 | 2.7 | 4.2 |
| Others, weight % | 3.0 | 1.4 | 1.7 |
| Cell constant, nm | 2.467 | — | 2.467 |
| Crystallinity, % | 66 | — | 18 |
| Specific surface area, m²/g | 558 | 205 | 263 |
| Average particle size, μm | 1.2 | 3.3 | 1.4 |

TABLE 15
Physical and chemical properties of the catalyst samples in the embodiments

| Code of catalyst | A | B | C | D | E | F | G |
|---|---|---|---|---|---|---|---|
| Aluminum oxide, weight % | 50.1 | 48.7 | 27.6 | 53.1 | 49.3 | 49.2 | 62.5 |
| Silica oxide, weight % | 43.0 | 46.5 | 68.5 | 44.2 | 45.2 | 48.7 | 31.3 |
| Sodium oxide, weight % | 0.2 | 0.1 | 0.2 | 0.1 | 0.2 | 0.1 | 0.2 |
| Ferric oxide, weight % | 2.4 | 1.6 | 2.4 | 1.3 | 1.7 | 0.9 | 3.5 |
| Rare earth oxide, weight % | 3.1 | 2.0 | — | — | 2.3 | — | 1.5 |
| Others, weight % | 1.2 | 1.1 | 1.3 | 1.3 | 1.3 | 1.1 | 1.0 |
| Average particle size, μm | 68.1 | 70.5 | 75.3 | 69.8 | 66.3 | 72.5 | 75.9 |
| Cell constant^{a)}, nm | 2.455 | 2.448 | 2,450 | — | 2,458 | — | 2,445 |
| Crystallinity^{a)}, % | 12 | 4 | 9 | — | 6 | — | 20 |
| Specific surface area^{a)}, m²/g | 250 | 330 | 310 | 175 | 195 | 223 | 279 |
| Pore volume^{a)}, ml/g | 0.42 | 0.45 | 0.45 | 0.38 | 0.39 | 0.39 | 0.41 |
| Apparent bulk density^{a)}, g/ml | 0.71 | 0.68 | 0.68 | 0.75 | 0.74 | 0.73 | 0.70 |
| Cell constant^{b)}, nm | 2.431 | 2.430 | 2.430 | — | 2.429 | — | 2.432 |
| Crystallinity^{b)}, % | 8 | 3 | 6 | — | 4 | — | 13 |
| Specific surface area^{b)}, m²/g | 127 | 130 | 135 | 80 | 88 | 112 | 129 |
| Pore volume^{b)}, ml/g | 0.30 | 0.30 | 0.31 | 0.26 | 0.26 | 0.28 | 0.29 |
| Apparent bulk density^{b)}, g/ml | 0.81 | 0.82 | 0.83 | 0.88 | 0.87 | 0.85 | 0.84 |
| Cracking activity, weight % | 65 | 60 | 45 | 45 | 62 | 47 | 57 |

^{a)}Fresh catalyst;
^{b)}Catalyst aged for 24 h at a temperature of 790° C. with existence of 100% vapor;

TABLE 16
Physical and chemical properties of the contrast catalyst samples

| Code of catalyst | A/ | B/ | C/ | D/ | E/ | F/ | G/ |
|---|---|---|---|---|---|---|---|
| Aluminum oxide, weight % | 50.7 | 49.5 | 28.7 | 53.7 | 49.4 | 49.2 | 63.2 |
| Silica oxide, weight % | 44.1 | 46.8 | 69.6 | 44.4 | 46.2 | 49.0 | 33.3 |
| Sodium oxide, weight % | 0.2 | 0.1 | 0.1 | 0.2 | 0.2 | 0.2 | 0.2 |
| Ferric oxide, weight % | 0.4 | 0.6 | 0.5 | 0.5 | 0.7 | 0.3 | 0.4 |
| Rare earth oxide, weight % | 3.2 | 2.0 | — | — | 2.2 | — | 1.7 |
| Others, weight % | 1.4 | 1.0 | 1.1 | 1.2 | 1.3 | 1.3 | 1.2 |
| Average particle size, μm | 65.7 | 73.4 | 71.8 | 71.8 | 75.5 | 71.2 | 75.6 |
| Cell constant^{a)}, nm | 2.454 | 2.449 | 2.449 | — | 2.457 | — | 2,445 |
| Crystallinity^{a)}, % | 12 | 4 | 9 | — | 6 | — | 20 |
| Specific surface area^{a)}, m²/g | 240 | 310 | 315 | 181 | 199 | 220 | 272 |
| Pore volume^{a)}, ml/g | 0.42 | 0.44 | 0.44 | 0.38 | 0.39 | 0.40 | 0.41 |
| Apparent bulk density^{a)}, g/ml | 0.71 | 0.69 | 0.58 | 0.75 | 0.75 | 0.73 | 0.71 |
| Cell constant^{b)}, nm | 2.428 | 2.427 | 2.429 | — | 2.426 | — | 2.428 |
| Crystallinity^{b)}, % | 6 | 2 | 4 | — | 3 | — | 8 |
| Specific surface area^{b)}, m²/g | 107 | 111 | 118 | 66 | 69 | 92 | 102 |
| Pore volume^{b),} ml/g | 0.28 | 0.29 | 0.29 | 0.22 | 0.23 | 0.26 | 0.25 |
| Apparent bulk density^{b)}, g/ml | 0.87 | 0.88 | 0.89 | 0.91 | 0.90 | 0.88 | 0.88 |
| Cracking activity, weight % | 55 | 48 | 36 | 38 | 55 | 32 | 46 |

^{a)}Fresh catalyst;
^{b)}Catalyst aged for 24 h at a temperature of 790° C. with existence of 100% vapor;

From the data in table 15 and table 16, it can be seen that the catalyst prepared by the method of the present invention has a structure which is more stable than that of the catalysts prepared by using the prior art. The present invented catalysts can keep structure stable in hydrothermal and high-temperature environment. In addition, the catalyst of the present invention has better catalytic cracking activity.

The above embodiments are only preferably embodiments of the present invention and shall not be regarded as limit of the present invention. Any modifications, equivalent changes and improvement made within the spirit and principle of the present invention shall fall within the protective scope of the present invention

1. A process for synthesizing porous inorganic material comprising:
step 1) calcinating natural clay;
step 2) adding the calcined clay into a silicon-contained solution, and mixing;
step 3) adding metal ions to the obtained slurry of step 2) and mixing;
step 4) crystallizing and filtering the obtained slurry of step 3) to obtain filer cakes; and
step 5) drying the obtained filer cakes of step 4) to obtain the porous inorganic material.

2. The process of claim 1, wherein in said step 1) the natural clay is calcined for 0.5-5 h at a temperature of 500˜1,000° C., in said step 3) the obtained slurry of step 2) is kept standing at room temperature for 12-48 h prior to adding said metal ions and mixing, in said step 4) the obtained slurry of step 3) is crystallized for 10-48 h at a temperature of 90˜250° C. in a sealed condition and in said step 5) the obtained filer cakes of step 4) are oven dried

3. The process of claim 1, wherein the natural clay is selected from the group consisting of: kaolinite, montmorillonite and illite.

4. The process of claim 1, wherein the natural clay has a content of the aluminum oxide of 20%˜50% by weight.

5. The process of claim 1, wherein the calcinating temperature of the natural clay in step 1) is 700˜850° C.

6. The process of claim 1, wherein the calcinating time in step 1) is 1-4 h.

7. The process of claim 1, wherein the silicon-contained solution of step 2) is water glass with a modulus of 1.0˜4.0.

8. The process of claim 1, wherein in step 3) the metal ions comprise at least one one of: iron, cobalt and nickel ions.

9. The process of claim 1, wherein the pH value of the slurry in step 3) is greater than 7.

10. The process of claim 1, wherein the porous inorganic material contains a crystalline aluminum silicate zeolite structure comprising: Y zeolite, ZSM-5 zeolite or a combination thereof.

11. The process of claim 1, wherein said porous inorganic material has a specific surface area of 70˜700 m²/g.

12. The process of claim 1, comprising: calcinating 50 g of kaolinite for 4.5 h at a temperature of 550° C., preparing 400 ml water glass solution with a modulus of 4.5 and adding and mixing the calcined kaolinite to said water glass solution, keeping standing for 24 h at room temperature, placing the slurry in a sealed container;
crystallizing the slurry for 32 h at a temperature of 75° C., then adding 8.2 g prepared ferric oxide hydrate, based on ferric oxide, into the slurry, stirring the mixed slurry to mix the iron and other ingredients, crystallizing the mixture for 28 h at a temperature of 95° C. in a sealed condition, cooling to room temperature, filtering and flushing the slurry to obtain the porous inorganic material.

13. The process of claim 1, comprising: calcinating 50 g of montmorillonite for 2.5 h at a temperature of 750° C., preparing 500 ml water glass solution with a modulus of 2.0 and adding and mixing the calcined montmorillonite to said water glass solution, keeping standing for 42 h at room temperature, placing the slurry in a sealed container; crystallizing the slurry for 40 h at a temperature of 85° C., then adding 5.5 g prepared cobalt oxide hydrate, based on cobalt oxide, into the slurry, stirring the mixed slurry to mix the cobalt and other ingredients, crystallizing the mixture for 36 h at a temperature of 95° C. in a sealed condition, cooling to room temperature, filtering and flushing the slurry to obtain the porous inorganic material.

14. The process of claim 1, comprising: calcinating 50 g of illite for 3.0 h at a temperature of 600° C., preparing 900 ml water glass solution with a modulus of 2.2, adding and mixing the calcined illite to said water glass solution, keeping standing for 15 h at room temperature, placing the slurry in a sealed container; crystallizing the slurry for 45 h at a temperature of 140° C., then adding 3.0 g prepared nickel oxide hydrate, based on nickel oxide, into the slurry, stirring the mixed solution to mix the nickel and other ingredients well, crystallizing the mixture for 46 h at a temperature of 205° C. in a sealed condition, cooling to room temperature, filtering and flushing the slurry to obtain the porous inorganic material.

15. The process of claim 1, comprising: calcinating 50 g of montmorillonite for 2.5 h at a temperature of 750° C., preparing 1,000 ml water glass solution with a modulus of 2.8, adding and mixing the calcined montmorillonite to said water glass solution, keeping standing for 38 h at room temperature, placing the slurry in a sealed container; crystallizing the slurry for 20 h at a temperature of 125° C., then adding 4.5 g prepared ferric oxide hydrate, based on ferric oxide, into the slurry, stirring the mixed solution to mix the nickel and other ingredients well, crystallizing the mixture for 40 h at a temperature of 220° C. in a sealed condition, cooling to room temperature, filtering and flushing the slurry to obtain the porous inorganic material.

16. The process of claim 1, comprising: calcinating 50 g of kaolinite for 2.0 h at a temperature of 800° C., preparing 1,000 ml water glass solution with a modulus of 2.5, adding and mixing the calcined kaolinite to said water glass solution, keeping standing for 24 h at room temperature, placing the slurry in a sealed container;
crystallizing the slurry for 32 h at a temperature of 95° C., then adding 4.8 g prepared ferric oxide hydrate, based on ferric oxide, into the slurry, stirring the mixed solution to mix the nickel and other ingredients well, crystallizing the mixture for 35 h at a temperature of 150° C. in a sealed condition, cooling to room temperature, filtering and flushing the slurry to obtain the porous inorganic material.

17. A process for preparing a petroleum hydrocarbon catalytic cracking catalyst using a porous inorganic material, characterized in that the catalyst comprises porous inorganic material, kaolin, pseudo-boehmite, silicon-contained solution and aluminum sol; the process comprising:
step 1) dispersing the pseudo-boehmite with water and controlling the solid content of the slurry to be 10%˜25% weight, adding hydrochloric acid solution according to a 0.10-0.35 acid-to-alumina ratio weight/weight, wherein the acid weight is the weight of hydrochloric acid solution containing 36% weight hydrochloric acid, and mixing;
step 2) adding the silicon-contained solution into the slurry obtained in step 1) while stirring, then adding aluminum sol solution, and mix;
step 3) adding a pre-dispersed porous inorganic material slurry and kaolin slurry into the slurry obtained in step 2), stirring the mixture to form a catalyst slurry; and
step 4) spray-forming the catalyst slurry, drying, washing, and calcinating the catalyst in a vapor atmosphere,

18. The process of claim 17, wherein the catalyst comprises in percentage by weight: 10%˜70% of porous inorganic material, 0%˜60% of kaolin, 0%˜30% of pseudo-boehmite, 0%˜15% of silicon-contained solution and 0%˜30% of aluminum sol.

19. The process of claim 17, wherein in step 2) the silicon-contained solution is slowly added into the slurry obtained in step 1) and stirred for 10-120 min.

20. The process of claim 17, wherein in step 3) the mixture is stirred for over 10 min to form said catalyst slurry.

21. The process of claim 17, wherein said silicon-contained solution is water glass with a modules of 2.9˜3.2.

22. The process of claim 17, wherein the steps for preparing the pre-dispersed porous inorganic material of step 3) comprise:
step 1) calcinating natural clay;
step 2) adding the calcined clay into a silicon-contained solution, and mixing;
step 3) adding metal ions metallic oxide to the obtained slurry of step 2) and mixing; and
step 4) crystallizing and filtering the obtained slurry of step 3) to obtain filer cakes and drying the obtained filer cakes.

23. The process of claim 22, wherein the steps for preparing the porous inorganic material further comprises washing the filer cakes obtained in step 4) using an aqueous solution of ammonium chlorate or ammonium chloride for exchange so as to remove free metallic ions.

24. The process of claim 22, wherein the preparation steps of the porous inorganic material further comprising in said step 1) the natural clay is calcined for 0.5-5 h at a temperature of 500˜1,000° C. in said step 3) the obtained slurry of step 2) is kept standing at room temperature for 12-48 h prior to adding said metal ions and mixing, in said step 4) the obtained slurry of step 3) is crystallized for 10-48 h at a temperature of 90-250° C. in a sealed condition and in said step 5) the obtained filer cakes of step 4) are oven dried.

25. The process of claim 22, wherein said natural clay is kaolin.

26. The process of claim 22, wherein said metal ions comprise ferric oxide.

27. The process of claim 17, wherein the porous inorganic material has a crystalline aluminosilicate structure comprising of: Y zeolite, MFI zeolite or a combination thereof.

28. The process of claim 27, wherein the MFI zeolite is ZSM-5.

29. A process for catalytic cracking of petroleum hydrocarbons using a porous inorganic material and catalyst, said process comprising:
contacting petroleum hydrocarbons and a catalyst at a temperature of 460˜680° C. with the existence of vapor; a catalyst-to-oil ratio is 4˜40 weight/weight; the vapor is 1%˜80% of the petroleum hydrocarbon weight; said catalyst includes by weight percentage: 10%˜70% of porous inorganic material, 0%˜50% of natural clay, 0%˜30% of pseudo-boehmite, 0%˜15% of silicon-contained sol and 0%˜30% of aluminum sol.

30. The process of claim 29, wherein said natural clay is kaolin.

31. The process of claim 29, wherein said petroleum hydrocarbons comprise one of:
vacuum gas oil, atmospheric residual oil, vacuum residual oil, coker gas oil, hydrogenated vacuum gas oil, hydrogenated atmospheric residual oil, hydrogenated vacuum residual oil, and hydrogenated coker gas oil.

32. The process of claim 29, wherein said petroleum hydrocarbons have a carbon residue content of 0%˜9.0% weight and a density of 0.85˜0.99 g/ml.

33. The process of claim 29, wherein the contact temperature between the petroleum hydrocarbons and the catalyst is 470˜550° C., the catalyst-to-oil ratio is 4˜12 weight/weight and the volume of the vapor is 10%˜70% weight of the petroleum hydrocarbons.

33. The process of claim 29, wherein the preparation steps of the catalyst comprise:
uniformly mixing the pseudo-boehmite, the silicon-contained sol, the aluminum sol, the porous inorganic material and the natural clay to obtain a catalyst slurry.

34. The process of claim 33, wherein said natural clay is kaolin.

35. The process of claim 33, further comprising spray-forming and drying said catalyst slurry, exchanging with at least one rare earth element, washing, drying, and calcinating in a hydrothermal atmosphere.

35. The process of claim 29, wherein the silicon-contained sol is water glass solution with a modulus of 2.9˜3.2 and a solid content of 5%˜15% weight.

36. The process of claim 29, wherein the content of the porous inorganic material is 30%˜60% weight; the content of the natural clay is 20%˜40% weight; the content of the pseudo-boehmite is 10%˜20% weight; and the content of the aluminum sol is 5%˜25% weight.

37. The process of claim 36, wherein said natural clay is kaolin.

38. The process of claim 29, wherein the preparation process of the porous inorganic material comprises: calcinating and activating natural clay, mixing the calcined natural clay with water glass solution, keeping standing, crystallizing, adding metal ions, re-crystallizing, washing and exchanging with: ammonium chloride, ammonium sulfate, lanthanum chloride, cerium chloride or a combination thereof.

38. The process of claim 37, wherein the natural clay is kaolin.

39. The process of claim 29, wherein the porous inorganic material comprises: a Y zeolite structure, a ZSM-5 zeolite structure or a combination thereof.

40. The process of claim 38, wherein the metal ions are ferric oxides.
